(19) United States
(12) Patent Application Publication
(10) Pub. No.: US 2005/0172323 A1
(43) Pub. Date: Aug. 4, 2005

(54) Television web services

(75) Inventors: Yu Yang, Beijing (CN); Zhi-Guang Zhou, Beijing (CN)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/768,257

(22) Filed: Jan. 30, 2004

(51) Int. Cl. H04N 7/173; G06F 17/24; G06F 17/21; G06F 17/00; G06F 15/00

(52) U.S. Cl. 725/109; 725/110; 725/112; 715/500.1; 715/501.1

(57) ABSTRACT

Television web services are described. In an implementation, a method includes exposing one or more web services over a web service interface to a plurality of applications. Each of the web services relates to television programming and at least two of the applications are not compatible with other. One or more requests received at the web service interface from at least one of the applications are processed by a corresponding one of the web services.

### TECHNICAL FIELD

The present invention generally relates to the field of television and more particularly relates to television web services.

### BACKGROUND

Television content providers continue to offer an ever increasing array of television content to users. For example, a user may view traditional television programming received over a broadcast network by using a client, such as a set-top box. The user may also view pay-per-view movies, order video-on-demand (VOD) content, interact with video games, and so on.

To provide this array of television content, a variety of new and pre-existing systems may be employed by the television content providers. A multiple systems operator (MSO), for instance, may include a plurality of head-ends to broadcast traditional television programming. The traditional television programming may be encrypted by the MSO using one or more proprietary encryption techniques for protection from unauthorized access. In such an instance, the user may utilize a device, such as a set-top box, that is provided by the MSO and includes encryption keys and other software and hardware resources needed to decrypt the television programming for viewing by the user. Therefore, the user may be limited to devices provided by the MSO in order to view the television programming, thereby limiting the permeability of the uses of the television programming.

Additionally, in order to provide new types of television content, the software and hardware resources of devices utilized to process the content may change. For example, a television content provider may offer enhanced television programming which may require the use of significant hardware and software resources. Thus, a user that wishes to access such enhanced television programming may need to purchase a new device capable of processing the enhanced television programming. As previously stated, however, each television content provider may also utilize proprietary encryption techniques which limit which devices may be utilized to access television programming. Therefore, the user may be further limited from accessing new types of television programming by pre-existing systems employed by the television content provider.

Therefore, there is a continuing need to improve techniques for providing and accessing television content.

### SUMMARY

Television web services are described. The television web services enable users to employ a heterogeneous collection of devices to access television content and services. For example, the television web services may expose to set-top boxes and other types of clients a set of web services interfaces that are standard-based and self-described. The web service interfaces may be utilized to provide an Application Programming Interface (API) such that a variety of devices executing a variety of applications may access the television web services without knowing the “particulars” of how such access is provided.

In an implementation, a method includes exposing one or more web services over a web service interface to a plurality of applications. Each of the web services relates to television programming and at least two of the applications are not compatible with each other. One or more requests received at the web service interface from at least one of the applications are processed by a corresponding one of the web services.

In an additional implementation, a method includes publishing a Web Services Description Language (WSDL) document that defines application-level behavior for interacting with one or more web services via a web service interface. Each of the web services relates to television programming. A client can be initialized at runtime based on the WSDL document to form a SOAP request for communication to the web service interface. The request is for routing by the web service interface to a corresponding web service for processing.

In a further implementation, an API for exposing a web service to one or more independent applications includes one or more methods callable by one of the independent applications over the Internet. Each of the independent applications is executable on a respective client. The one or more callable methods accept arguments that are passable through the web service interface and routed to a corresponding one or more of the web services. The web services relate to television programming.

### BRIEF DESCRIPTION OF THE DRAWINGS

FIG. 1 is an illustration of an environment in an exemplary implementation that includes a plurality of service providers, a plurality of edge servers, and a plurality of clients.

FIG. 2 is an illustration of a system in an exemplary implementation that includes the client, an edge server, and the plurality of service providers and respective web services of FIG. 1.

FIG. 3 is an illustration of a system in an exemplary implementation showing the edge server and client of FIG. 1 in greater detail.

FIG. 4 is a flow diagram depicting a procedure in an exemplary implementation in which the client of FIG. 1 is authenticated and configured to interact with one or more web services.

FIG. 5 is a flow chart depicting a procedure in an exemplary implementation in which the client is configured based on the WSDL document received from the edge server in FIG. 4 and interacts with one or more web services through the web service interface.

FIG. 6 is a flow chart depicting a procedure in an exemplary implementation in which the client of FIG. 3 is configured based on a published WSDL document for interaction with a web service interface that provides television web services.

FIG. 7 is an illustration of an exemplary operating environment.

The same reference numbers are utilized in instances in the discussion to reference like structures and components.

### DETAILED DESCRIPTION

Overview

Television Web Services (television services) are described herein as enabling users to employ a heterogeneous collection of devices to access television functionality. For example, the television services may expose to set-top boxes and other types of clients a set of web service interfaces that are standards-based and self-described. The web service interfaces may be utilized to provide an Application Programming Interface (API) such that a variety of devices executing a variety of applications may access the television services without knowing the “particulars” of how such access is provided.

Through use of the web service interfaces, a variety of applications and devices may utilize the television services. For example, devices and applications may provide requests through the web service interfaces that are processed by the television services. A result of the processing may then be received without knowing how and/or where the processing occurred. Therefore, traditional and prospective devices and applications may be configured to utilize the television services. For instance, devices and applications that were previously developed and have yet to be developed may utilize the functionality provided by the television services. In addition, the utilization of television services would may be easier than those based on proprietary communication rules, since web services often utilize open and straightforward standards that are widely adopted by industry.

The web service interfaces may also be utilized to “insulate” the television services from the clients. In this way, the television services may be controlled by the service providers, and thus protect propriety encryption techniques, protocols, and methods of providing the television services. Therefore, changes may be made to the television services, new television services may be added, and so forth without requiring changes to the devices and applications that consume the television services.

Exemplary Environment

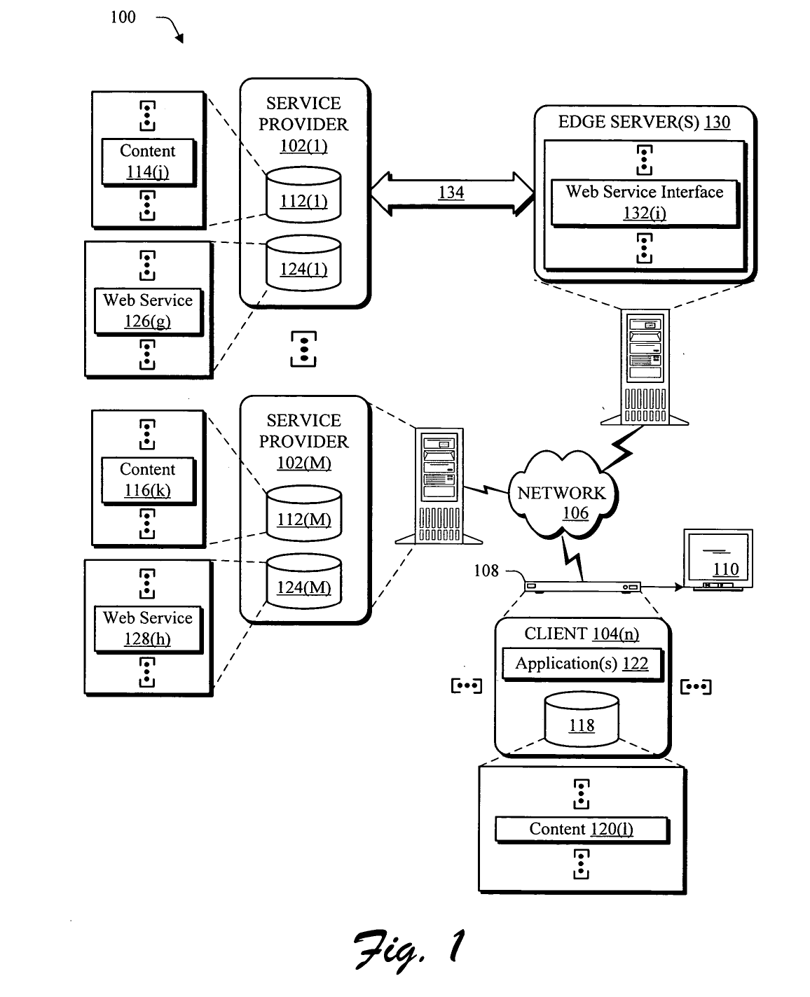

FIG. 1 is an illustration of an environment 100 in an exemplary implementation that includes a plurality of service providers 102(l)-102(M) and a plurality of clients 104(n), where “n” can be any integer from one to “N”. The client 104(n) may be configured in a variety of ways. For example, the client 104(n) may be configured as a computer that is capable of communicating over a network 106, such as a desktop computer, a mobile station, an entertainment appliance, a set-top box 108 communicatively coupled to a display device 110 as illustrated, a wireless phone, and so forth. The client 104(n) may range from a full resource device with substantial memory and processor resources (e.g., television enabled personal computers, television recorders equipped with hard disk) to a low-resource device with limited memory and/or processing resources (e.g., traditional set-top boxes). The client 104(n) may also relate to a person and/or entity that operates the client. In other words, client 104(n) may describe a logical client that includes a user and/or a machine. The network 106 is illustrated as the Internet, and may include a variety of other wide area networks (WANs), such as an intranet, a wired or wireless telephone network, a satellite network, a cable network, a digital subscriber line (DSL) network, a broadcast network with a backchannel to provide two-way communication, and so forth.

As illustrated in FIG. 1, service provider 102(l) may include a storage device 112(l) having a plurality of content 114(j), where “j” can be any integer from 1 to “J”. Likewise, service provider 102(M) may include a storage device 112(M) having a plurality of content 116(k), where “k” can be any integer from 1 to “K”. The plurality of content 114(j), 116(k) may be configured in a variety of ways, such as television programming, video-on-demand (VOD), one or more results of remote application processing, and so on. The content 114(j), 116(k) is communicated over the network 106 for receipt by the client 104(n).

Each client 104(n) may be configured in a variety of ways to receive the content 114(j), 116(k) over the network 106. As illustrated, client 104(n) is configured as a set-top box 108 that is communicatively coupled to a display device 110. The client 104(n) includes hardware and software to transport and decrypt content 1140), 116(k) received from the service providers 102(l)-102(M) for rendering by the display device 110. Although a display device 110 is shown, a variety of other output devices are also contemplated, such as speakers.

The client 104(n) may also include digital video recorder (DVR) functionality. For instance, the client 104(n) may include a storage device 118 to record content 120(l) received from the network 106 for output to and rendering by the display device 110. The storage device 118 may be configured in a variety of ways, such as a hard disk drive, a removable computer-readable medium (e.g., a writable digital video disc), and so on. Content 120(l), where “1” can be any integer from “1” to “L”, that is stored in the storage device 118 of the client 104(n) may be copies of the content 1140), 116(k) received from the service providers 102(l)-102(M) over the network 106. Additionally, content 120(l) may be obtained from a variety of other sources, such as from a computer-readable medium that is accessed by the client 104(n), and so on.

The client 104(n) includes one or more applications 122 that are executable on the client 104(n) to control content playback on the client 104(n), such as through the use of one or more “trick modes”. The trick modes may provide non-linear playback of the content 120(l) (i.e., time shift the playback of the content 120(l)) such as pause, rewind, fast forward, slow motion playback, and the like. For example, during a pause, the client 104(n) may continue to record the content 114(j), 116(k) received from the service providers 102(l)-102(M) in the storage device 118 as content 120(l). The client 104(n), through execution of the application 122, may then playback the content 120(l) from the storage device 118, starting at the point in time the content 120(l) was paused, while continuing to record the currently-broadcast content 114(j), 116(k) in the storage device 118.

When playback of the content 120(l) is requested, the application 122 is executed on the client 104(n) to retrieve the content 120(l). The application 122 may also restore the content 120(l) to the original encoded format. For example, when the content 120(l) is recorded on the storage device 118, the content 120(l) may be compressed. Therefore, when the application 122 retrieves the content 120(l), the content 120(l) is decompressed for rendering by the display device 110.

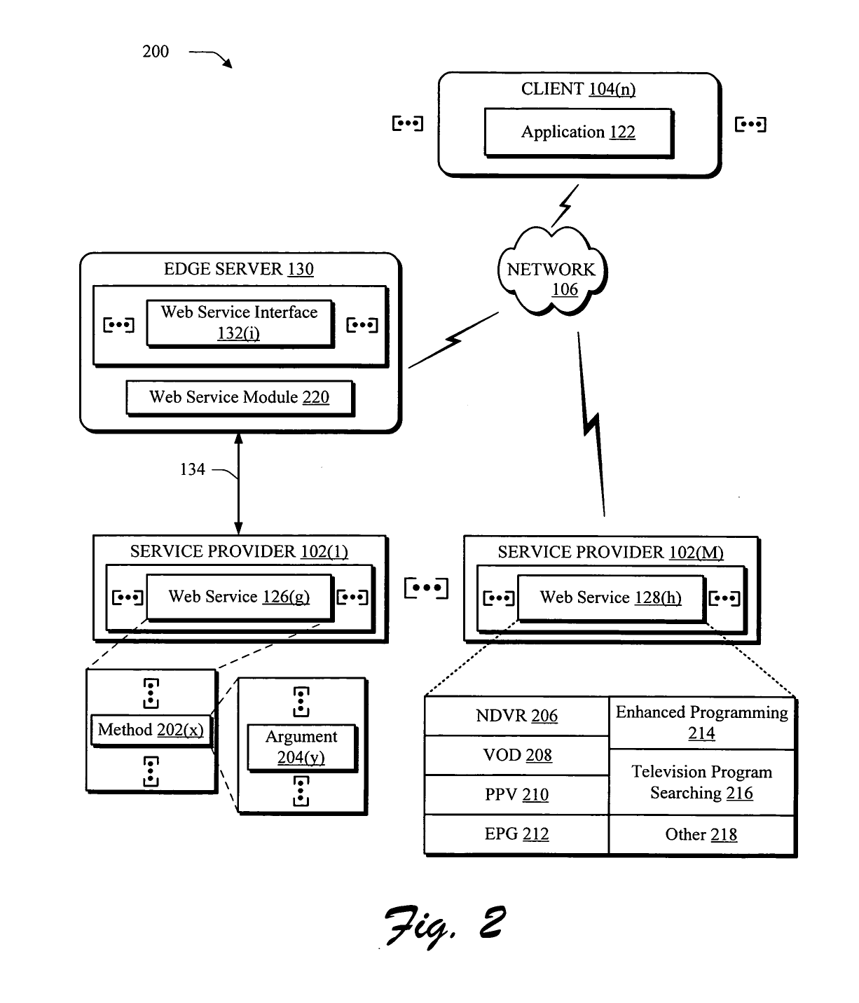

The application 122 may be executed on the client 104(n) to provide access to a wide range of additional television functionality. For example, each of the service providers 102(l)-102(M) may include a respective database 124(l)-124(M) of respective web services 126(g), 128(h), where “g” and “h” can be any integer from one to “G” and “H”, respectively. One or more of the web services 126(g), 128(h) may be configured to provide television services, such as electronic program guides (EPGs), which is described in greater detail in relation to FIG. 2. Although each of the plurality of service providers 102(l)-102(M) is illustrated as providing content and web services, the service providers may be configured in a variety of ways. For example, one or more of the plurality of service providers 102(l)-102(M) may be configured to provide web services, such as EPG data, without providing content.

An edge server 130 is also communicatively coupled to the network 106. The edge server 130 includes a plurality of web service interfaces 132(i), where “i” can be any integer from one to “I”, that are configured such that the client 104(n) may interact with the plurality of web services 126(g), 128(h). For example, the edge server 130 may be communicatively coupled with the service provider 102(l) over a network 134. The network 134 may be the same as or different from network 106. Networks 106 and 134, for instance, may both be configured as WANs, such as the Internet, network 134 may be a local area network (LAN), and so on. Service provider 102(M) is illustrated as communicatively coupled to network 106.

The plurality of web service interfaces 132(i) provide routing of requests initiated by the client 104(n) to a corresponding one of more of the service providers. Additionally, the plurality of web service interfaces 132(i) may provide routing of responses to the requests from one or more of the service providers 102(l)-102(M) to the client 104(n). Thus, the web service interfaces 132(i) insulate the service providers 102(l)-102(M) from the client 104(n) such that the client 104(n) does not need to know the “particulars” of where and/or how the request is processed. In this way, the web service interfaces 132(i) provide the web-services 126(g)-128(h) to a wide variety of clients 104(n) as previously described. Although a single edge server 130 is shown, a plurality of edge servers may be utilized to provide the plurality of web service interfaces 132(i).

FIG. 2 is an illustration of a system 200 in an exemplary implementation that includes the client 104(n), edge server 130, and plurality of service providers 102(l)-102(M) and respective web services 126(g), 128(h) of FIG. 1. Web services 126(g), 128(h) extend the functionality of the Internet by providing a basis for software to connect to other software applications. As previously described, web services 126(g), 128(h) provide computer functionality in a way that may be used by a diverse range of devices, using different networks and protocols, to provide various functions. A web service typically provides a specific element of functionality to service a specific request, such as data relating to a topic, data processing, and the like. For instance, a web service may perform a mathematical function, return requested data, and the like. In additional implementations, the web service provides multiple elements of functionality, such as EPG data and television program searching.

Web services 126(g), 128(h) provide application logic that is programmatically available. For example, web service 126(g) may be called by application 122 through the web service interface 132(i) and receive data in a format that may be accessed and processed by the application 122. By providing application logic that is programmatically available, web services 126(g), 128(h) may be accessed in a variety of ways. A web service, for instance, may be accessed by an application implemented internally within a computer, by a computer over an intranet, by a computer over the Internet, and the like. Additionally, a web service may use open Internet standards so that it may be accessed by a wide range of users in a seamless manner. For instance, an application running locally on a user's computer may access the web service using open Internet standards directly.

Each web service 126(g) supports one or more methods 202(x), where “x” can be any integer from one to “X”. Although in the illustrated example of FIG. 2 web service 126(g) is shown as supporting a plurality of methods 202(x), a web service may also support a single method. Additionally, each method 202(x) may support one or more arguments 204(y), where “y” can be any integer from one to “Y”. Service provider 102(l), for instance, may provide a web service 126(g) having method 202(x) for locating a particular television program. To find the particular television program, a user may specify a name of the television program, which is supplied as an argument for the method 202(x) of a web service 126(g). For example, the service provider 102(l) has a method 202(x) configured as “query<television_program>” which accepts a user-supplied argument 204(y) “football” to specify a particular television program.

The web service interfaces 132(i) may be thought of as an interface for the client 104(n) to communicate with the plurality of web services 126(g), 128(h). The web service interfaces 132(i) provide communication for the client 104(n) to call methods 202(x) which may operate in different execution environments, such as in a different application, on a different thread, in another process, remotely on another computer, and the like. The web service interfaces 132(i) may be configured to expose a replica of the methods 202(x) of the web service 126(g). Through the exposed methods 202(x), interaction with the web service interfaces 132(i) effectively invokes the methods 202(x) of the web service 126(g). Thus, the web service interface 132(i) may be thought as an interface for the methods 202(x) included on the web services 126(g) which actually perform the “work”. In an implementation, the web service interfaces 132(i) are used by the client 104(n) as if the methods 202(x) were locally available. By using the web service interfaces 132(i), the methods 202(x) available on the web service 126(g) may be accessed without the client 104(n) “knowing” where the methods 202(x) are located and implemented. For instance, through use of the web service interface 132(i), the web services 126(g), 128(h) may be accessed over the respective networks 134, 106 without informing the application 122 of where the web services 126(g), 128(h) are located and/or how the web services 126(g), 128(h) perform the respective methods.

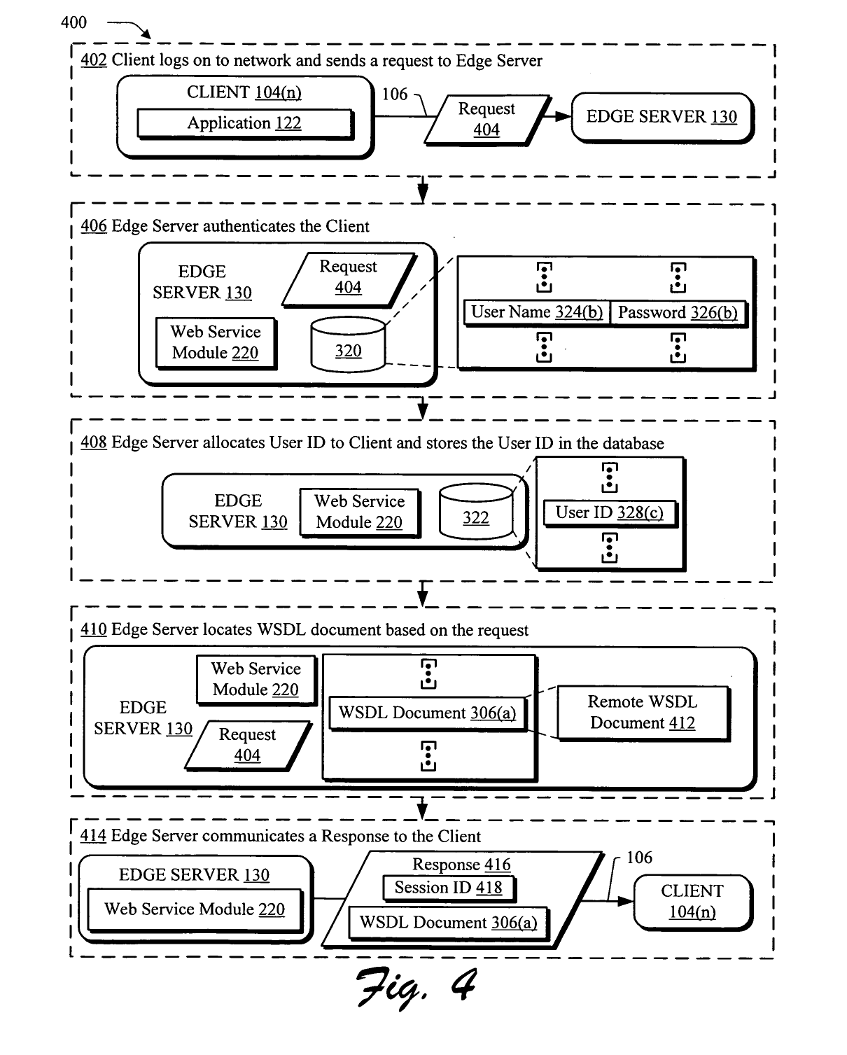

To invoke the methods 202(x) of the web services 126(g), for example, the client 104(n) uses the application 122 to invoke the web service interface 132(i), and particularly the method 202(x) of the web service interface 132(i). The web service interface 132(i) acts as an interface for the methods 202(x) of the web service 126(g) so that it appears to the client 104(n) that the methods 202(x) are available locally on the edge server 130. The web service interface 132(i) takes a request from the application 122 and transfers the request over the network 134 to the web service 126(g) and invokes the method 202(x). The method 202(x) of the web service 126(g) produces a result that is returned through the web service interface 132(i). The web service interface 132(i) then exposes the result to the application 122. Further discussion of operation of the web services are discussed in relation to FIG. 4.

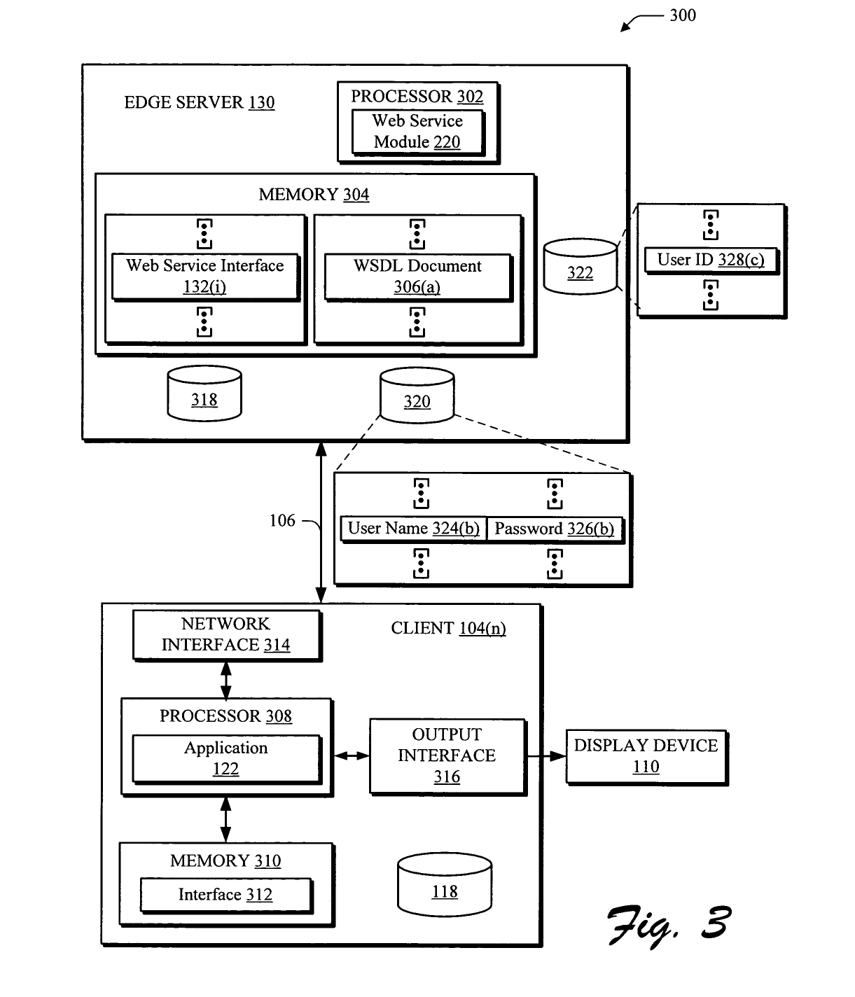

The web services 126(g), 128(h) may be configured to provide a variety of television services. Web service 128(h), for example, may be configured to provide network digital video recorder (NDVR) services 206, video-on-demand (VOD) 208 services, pay-per-view (PPV) 210 services, electronic programming guide (EPG) services 212, enhanced programming 214, television program searching 216, and other 218 television services, such as digital rights management (DRM), t-commerce, and so on. To manage the provision of the web service interfaces 132(i), the edge server 130 may employ a web service module 220. Execution of the web service module 220 is described in greater detail in relation to FIGS. 3 and 4. Each of the exemplary television services will be described in the following discussion.

Network Digital Video Recorder (NDVR) 206 Services

As previously described, the client 104(n) may be configured as a DVR which includes the storage device 118 of FIG. 1 to record content 120(l) received from the network 106 for output to and rendering by the display device 110. The application 122 may be utilized by the client 104(n) to control content playback on the client 104(n), such as through the use of one or more “trick modes”. The trick modes may provide non-linear playback of the content. Non-linear playback may include time shifting the playback of the content, such as pause, rewind, fast forward, slow motion playback, and the like.

The service provider 102(M) may also provide similar functionality to the client 104(n) over the network 106 by providing NDVR 206 services. For example, the application 122, when executed, may form a request for communication to the service provider 102(M) over the network 106 to record a particular television program. The web service 128(h), upon receipt of the request through the web service interface 132(i), records the particular television program. When the client 104(n) wants to watch the recorded television program, the television program may be streamed from the service provider 102(m) to the client 104(n) over the network 106.

Video-on-Demand (VOD) 208 Services

VOD 208 services enable the client 104(n) to view television content when desired, instead of at a predetermined point-in-time. VOD 208 services may also provide trick modes to the client 104(n), such as to enable the client 104(n) to pause, fast forward, rewind, and provide slow motion playback. The VOD 208 service, for instance, may stream content stored at the service provider 102(M) to the client 104(n) over the network 106. The client 104(n) may initiate one or more trick modes through execution of the application 122. The trick modes in this instance are used to control the streaming of the content to client 104(n). Thus, a user of the client 104(n) may pause, fast-forward, and rewind the playback of the content at the client like the DVR example through communication with the VOD 208 service. The VOD 208 service may also provide client authentication, which is described in greater detail in relation to FIG. 4.

Pay-Per-View (PPV) 210 Services

PPV 210 services are similar to VOD 208 services. PPV 210 services, however, generally provide television content at a predetermined point-in-time. Therefore, the client 104(n) generally purchases rights to access content that is broadcast at predetermined points-in-time. PPV 210 services may also include authentication of the client 104(n) to access the services, such as to collect identification and billing information of the client 104(n).

Electronic Program Guide (EPG) 212 Services

EPG 212 services enable the client 104(n) to navigate through television program listings and descriptions. For example, the EPG 212 services may supply a listing of television programs for broadcast during selected periods of time. The listing may also include television programs that are available for access, such as VOD 208 services, PPV 210 services, and so on.

Enhanced Programming 214 Services

Enhanced programming 214 services are generally utilized to provide informative content that is related to television content that is being rendered by a display device. For example, enhanced programming 214 services may be utilized to provide content that is integrated with a broadcast of a television program to promote an interactive experience, such as a play-along game show, fantasy sports, and so on.

Television Program Searching 216 Services

Television program searching 216 services may be utilized by the client 104(n) to locate desired television programming. For example, the television programming searching 216 services may be utilized in conjunction with the EPG 212 services to navigate to a particular television program of interest by supplying data for one or more searchable fields. Examples of searchable fields include program title, actor, genre, duration, broadcast time, and so on.

Other 218 Services

Although a variety of television services have been described, other 218 services may also be provided, such as digital rights management (DRM) services, t-commerce, and so forth. DRM services may be utilized to control access to content. For example, television programming may be encrypted utilizing one or more encryption keys. Therefore, to access the content, the client 104(n) forms one or more requests for accessing the content that are communicated to the service provider 102(M). The service provider 102(M), in response to the requests, may then determine whether the client 104(n) has rights to access the content, obtain billing information, and so on. If the client 104(n) has rights to access the content, the service provider 102(M) may communicate a license that includes access rules that specify the rights of the client 104(n) for accessing the content and one or more decryption keys for decrypting the content. Thus, the client 104(n) may access the television programming according to the access rules specified in the license provided through execution of the DRM services.

Television commerce, in what may be referred to as “t-commerce”, enables users of the client 104(n) to purchase goods and/or services in a manner similar to electronic commerce or “e-commerce”. For example, a user of the client 104(n) may utilize a remote control, instead of a keyboard, to purchase at item that is displayed on the display device 110 of FIG. 1. Such as service has proven appeal in certain demographics where users do not feel comfortable with computers but still wish to avail themselves of the convenience of shopping from home.

FIG. 3 is an illustration of a system 300 in an exemplary implementation showing the edge server 130 and the client 104(n) of FIG. 1 in greater detail. The edge server 130 includes a processor 302 and memory 304. The web service module 220 is illustrated as being executed on the processor 302 and is storable in memory 304. The plurality of web service interfaces 132(i) are illustrated as being stored in memory 304 and are executable on the processor 302. The memory 304 is also illustrated as storing a local web service description language (WSDL) document 306(a), describing web service interfaces 132(i), where “a” can be any integer from one to “A”. The WSDL documents 306(a) may be utilized to describe message formats and interface specifications for interacting with one or more corresponding web service interfaces 132(i), and through which the corresponding web services 126(g), 128(h) of FIG. 1. For example, the WSDL document 306(a) may define an eXtended Markup Language (XML) grammar for describing the web services 132(i) of FIG. 1 in an abstract format such that the client 104(n) may determine what web services are offered and how to interact with the web services through the web service interfaces 132(i).

The client 104(n), for instance, may download a WSDL document 306(a) and then configure itself according to the WSDL document 306(a) at runtime for communication with the web services 132(i) of FIG. 1. For example, the client 104(n) includes a processor 308 and memory 310. The application 122 is illustrated as being executed on the processor 308 and is storable in memory 310. In an implementation, the application 122, upon receipt of the WSDL documents 306(a), may parse the WSDL document 306(a) and configure itself accordingly such that the application 122 may initiate one or more SOAP client objects used to invoke the web services 132(i). In another implementation, an interface 312 is configured for communication with the web service interfaces 132(i). For instance, the interface 312 may be configured as a software module such that each application executed on the client 104(n) provides requests through the interface 312. In such an instance, the interface 312 may act to translate and route the requests to the web service interfaces 132(i). Therefore, in this instance, the application 122 is not modified for interaction with the web service interfaces 132(i).

The client 104(n) also includes a network interface 314 for communication over the network 106 with the edge server 130. The client 104(n), for instance, may form a request for interaction with the web service interfaces 132(i) that is communicated using the network interface 314 and receive a response to the request over the network interface 314. The response may then be output using an output interface 316 for rendering by the display device 110. As previously described, the client 104(n) may also include the storage device 118 to store the plurality of content 120(l) of FIG. 1. Although the storage device 118 is illustrated as separate from the memory 310, the memory 310 may also include the storage device 118. For example, the storage device 118 may be configured as a hard disk drive and the memory 310 may be configured as RAM, both the memory 310 and the storage device 118 may be configured as RAM, one or both of the memory 310 and the storage device 118 may be configured as removable memory, and so forth.

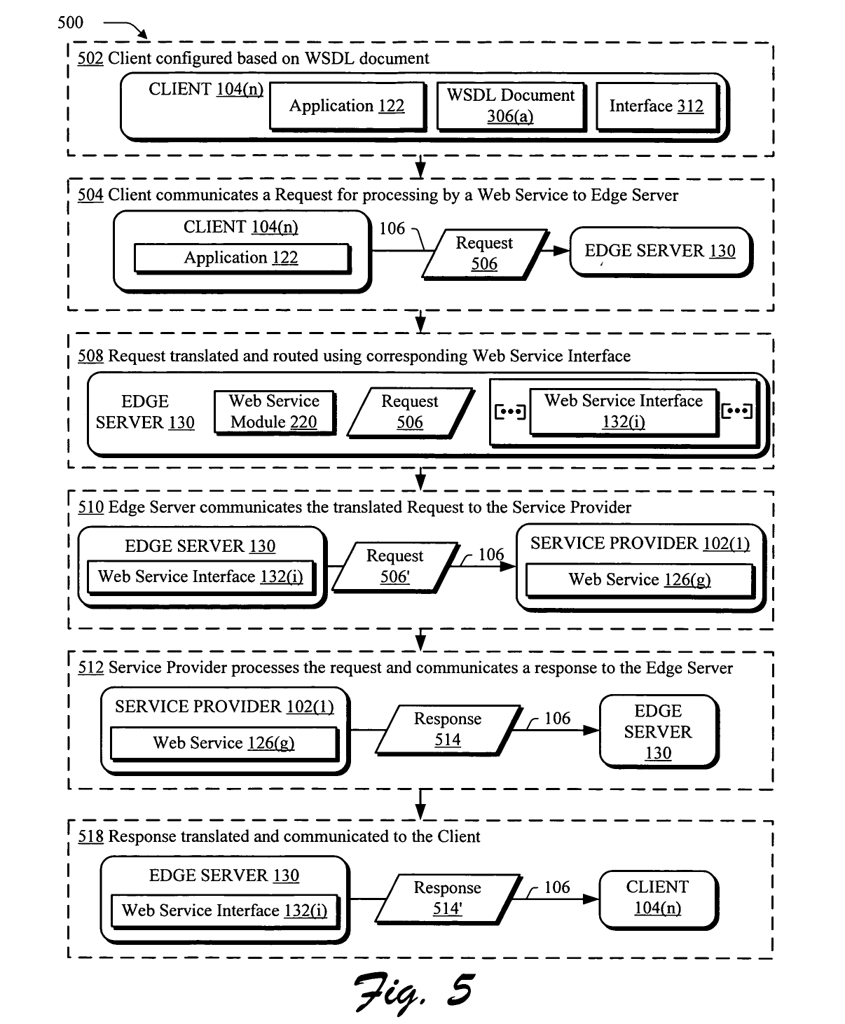

The edge server 130 also includes storage devices 318, 320, 322. Storage device 318 may be utilized to store the content received from one or more of the service providers 102(l)-102(M) of FIG. 1. Storage devices 320, 322 may be utilized to store data to authenticate the client 104(n) for interaction with the web services 126(g), 128(h) of FIG. 1. Storage device 320, for instance, may store user names 324(b) and passwords 326(b), where “b” can be any integer from one to “B”, of the clients 104(n). Upon authentication of the client 104(n) by comparing a supplied user name and password with a corresponding user name 324(b) and password 326(b) in the storage device 320, the edge server 130 may supply a session ID, which may be calculated based on time stamp and client IDs 328(c) from the storage device 322. The session ID may be utilized by the edge server 130 to identify a request from the client 104(n) and send a response to the request back to the particular client 104(n), further discussion of which is described in relation to FIG. 5. Although each of the storage devices 318, 320, 322 is illustrated separately, one or more of the storage devices 318-322 may be combined to form a single device. Additionally, one or more of the plurality of storage devices 318-322 may be included within the memory 304 of the edge server 130.

Exemplary Procedures

FIG. 4 is a flow diagram depicting a procedure 400 in an exemplary implementation in which the client 104(n) is authenticated and configured to interact with one or more of the web services 126(g), 128(h) of FIG. 1. At block 402, the client 104(n) logs onto the network 106 and sends a request 404 to the edge server 130. The request 404 is for accessing one or more of the web services 126(g), 128(h) of FIG. 1 and includes a user name and password specific to the client 104(n).

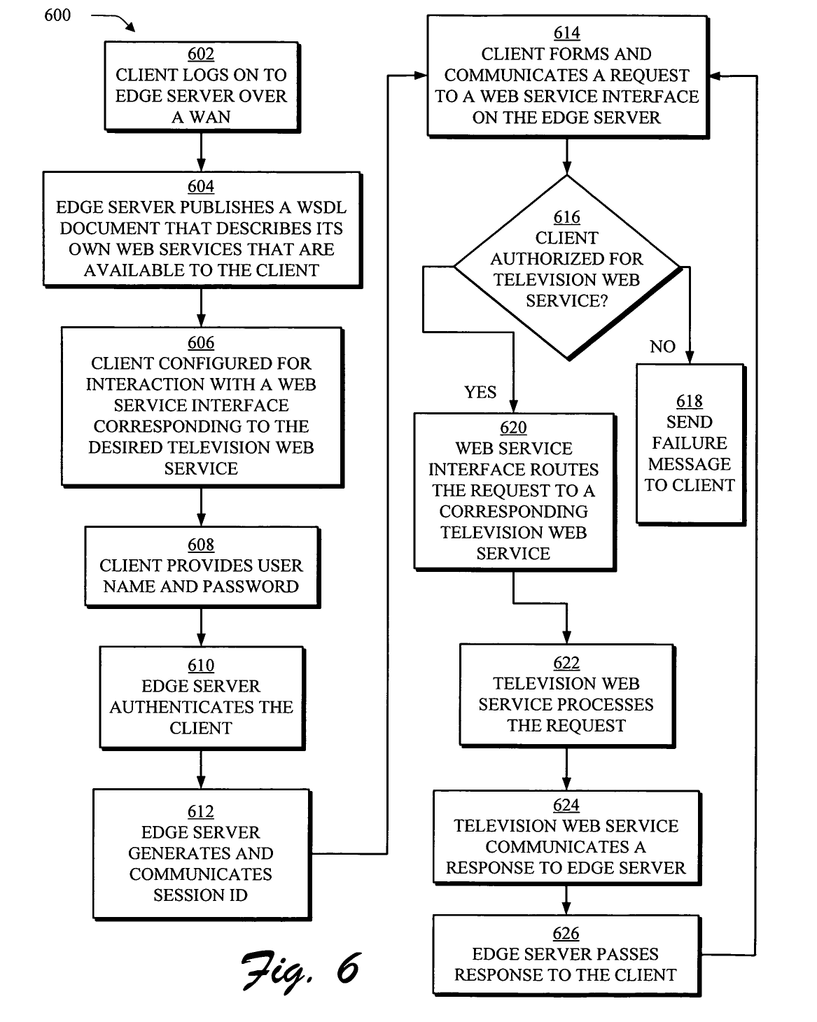

At block 406, the edge server 130 authenticates the client 104(n) for interaction with the web services 126(g), 128(h) of FIG. 1. For example, the edge server 130 may execute the web service module 220 to compare a user name and password in the request 404 with a corresponding user name 324(b) and password 326(b) stored in the storage device 320. The user name 324(b) and password 326(b) may be utilized to identify access rights of the client 104(n) with the web services 126(g), 128(h) of FIG. 1, which will be described in greater detail in relation to FIG. 6.

At block 408, the edge server 130, through execution of the web service module 220, allocates a session ID and stores the logon information in a database maintained on the storage device 322 for each user, which is represented at block 308 as user ID 328(c). The session ID is utilized to identify the particular client 104(n) such that requests generated by the client 104(n) and responses to the requests may be routed accordingly. For example, a plurality of clients 104(n) may interact with the plurality of web services 126(g), 128(h) which are provided, respectively, by the plurality of service providers 102(l)-102(M). Therefore, the requests may include the session ID to identify each request initiated by a particular one of the plurality of clients 104(n) with a particular one of the plurality of clients 104(n). Additionally, the plurality of user IDs 328(c) may be utilized to identify access rights of each particular client 104(n) to the content 114(j), 116(k) and web services 126(g), 128(h) of FIG. 1.

At block 410, the edge server 130, through execution of the web service module 220, locates one or more of a plurality of WSDL documents that correspond to the web service 126(g), 128(h) for the request 404. The request 404, as previously stated, may identify one of the web service interfaces 132(i) of FIG. 1. The web service module 220, when executed on the edge server 130, locates one or more of the plurality of WSDL documents of television web services that correspond to the web services 126(g), 128(h) required in responding the request 404. The plurality of WSDL documents 306(a) may include one or more remote WSDL documents 412 that define application-level behavior for interacting with its corresponding web services 126(g), 128(h) of FIG. 1 via one or more of the web service interfaces 132(i).

At block 414, the edge server 130 communicates a response 416 to the client 104(n) that includes the allocated session ID 418 from block 408 and the local WSDL document 306(a) to the client 104(n) over the network 106. In this way, the client 104(n) is provided with WSDL documents 306(a) that may be utilized to configure the client 104(n) for interaction with the web service interfaces 132(i), and thereby one or more of the web services 126(g), 128(h), which is described in greater detail in the following implementation.

FIG. 5 is a flow chart depicting a procedure 500 in an exemplary implementation in which the client 104(n) is configured based on the WSDL document 306(a) received from the edge server 130 in FIG. 4 and interacts with one or more web services through the web service interface 132(i). At block 502, the client 104(n) is configured based on the WSDL document 306(a) for interaction with the web service interface 132(i), and therefore one or more of the web services 126(g), 128(h) of FIG. 1. The client 104(n) may be configured in a variety of ways. In a first example, the application 122 is configured according the WSDL document 306(a) such that requests and responses generated and received by the application 122 conform to the XML grammar for describing the web service interface 132(i) of FIG. 1 in an abstract format such that the application 122 may interact with the web services 126(g), 128(h) of FIG. 1 through one or more of the web service interfaces 132(i).

In another example, an interface 312 is configured on the client 104(n) such that each application executed on the client 104(n) need not be configured separately. For instance, the client 104(n) may execute a plurality of applications that utilize one or more of the web services 126(g), 128(h) of FIG. 1. The interface 312 may be configured to translate, form and route requests from the plurality of applications to a corresponding the web service interface 132(i) without the applications “knowing” that the requests were processed remotely over the network 106.

At block 504, the client 104(n) forms and communicates a request 506 for processing by a web service 126(g) to the edge server 130. The request 506 is formed in accordance with the WSDL document 306(a) and thereby complies with the application-level behavior described by the WSDL document 306(a).

At block 508, the request 506 is translated and routed using a corresponding web service interface 132(i). The edge server 130, for example, may translate the request 506 using the web service interface 132(j) such that the translated request, denoted by reference number 506′ to indicate that the translated request 506′ corresponds to the request 506, is understandable by a corresponding web service. In another example, the request 506 is not translated by the web service interface 132(i) and is routed “as-is” to the corresponding web service through use of the web service interface 132(i). In a further example, the web service module 220 is executed by the edge server 130 to route the request to a corresponding one of the plurality of web service interfaces 132(i) identified in the request 506.

At block 510, the edge server 130, through use of the web service interface 132(i), communicates the translated request to the content provider 102(l) over the network 106. The service provider 102(l) includes the web service 126(g) corresponding to the web service specified in the request 506. At block 512, the service provider 102(l) processes the translated request 506′ using the web service 126(g) and communicates a response 514 to the edge server 130. The web service 126(g) relates to television programming, and therefore may also be referred to as a television web service. A variety of television web services may be provided, such as NDVR 206 services, VOD 208 services, PPV 210 services, EPG 212 services, enhanced programming 214 services, television program searching 216 services, and other 218 services, such as DRM services and t-commerce services as was described in relation to FIG. 2. The response 514 includes a result of the processing of the translated request 506′.

At block 518, the response 514 is translated and the translated response 514′ is communicated to the client 104(n) over the network 106. The translated response 514′ is denoted by reference number 514′ to indicate that the translated response 514′ corresponds to the response 514. For example, the web service interface 132(i) may translate the response 514 received from the service provider 102(l) using the web service interface 132(i) such that the response 514 conforms to the grammar described by the WSDL document 306(a). Thus, a response 514 provided by the service provider 102(l) that does not conform to the response format described by the WSDL document 306(a) may be translated such that it does conform. In this way, the client 104(n) is provided with a response having an “expected” format as described by the WSDL document 306(a). In another implementation, the web service interface 132(i) does not translate the response 514, but rather routes the response to the client 104(n) “as is”.

FIG. 6 is a flow chart depicting a procedure 600 in an exemplary implementation in which the client of FIG. 3 is configured based on a published WSDL document for interaction with a web service interface that provides television web services. At block 602, the client logs on to the edge server over a wide area network (WAN), such as the Internet. At block 604, the edge server publishes a WSDL document which describes web services that are available to a client through the edge server. For example, the edge server may publish the documents to a Universal, Description, Discovery and Integration (UDDI) registry such that the client may locate the WSDL documents over the WAN.

At block 606, the client is configured for interaction with a web service interface corresponding to the desired television web service. The web service interface, for instance, may correspond to a particular television web service and route requests received at the web service interface to the particular television web service. At block 608, the client provides a user name and password, which is authenticated by the edge server at block 610. At block 612, as previously described, the edge server generates a session ID that corresponds to the client, and that is based on user ID and logon time stamp and so on. The user ID is stored by the edge server and the session ID is communicated to the client.

At block 614, the client forms and communicates a request to a web service interface on the edge server. The request is communicated and formatted as described by the WSDL document published by the edge server at block 604. The request may also include the previously obtained session ID. At block 616, the edge server determines whether the client is authorized to consume the television web service 616. If the client is not authorized, a failure message is sent to the client at block 618. If the client is authorized, then at block 620, the web service interface routs the request to a corresponding television web service. In this way, the edge server insulates other servers that provide the television web services from the client such that the client is not aware of where and/or how the web service is provided. Thus, the edge server acts as a portal for the other servers.

At block 622, the television web service processes the request. For example, the television web service may locate a desired television program, provide EPG data for a desired interval of time, authenticate the user to receive VOD content, and so forth. At block 624, the television web service communicates a response to the request to the web service on the edge server, and edge server in turn passes the result to the client over the network, at block 626.

Exemplary Operating Environment

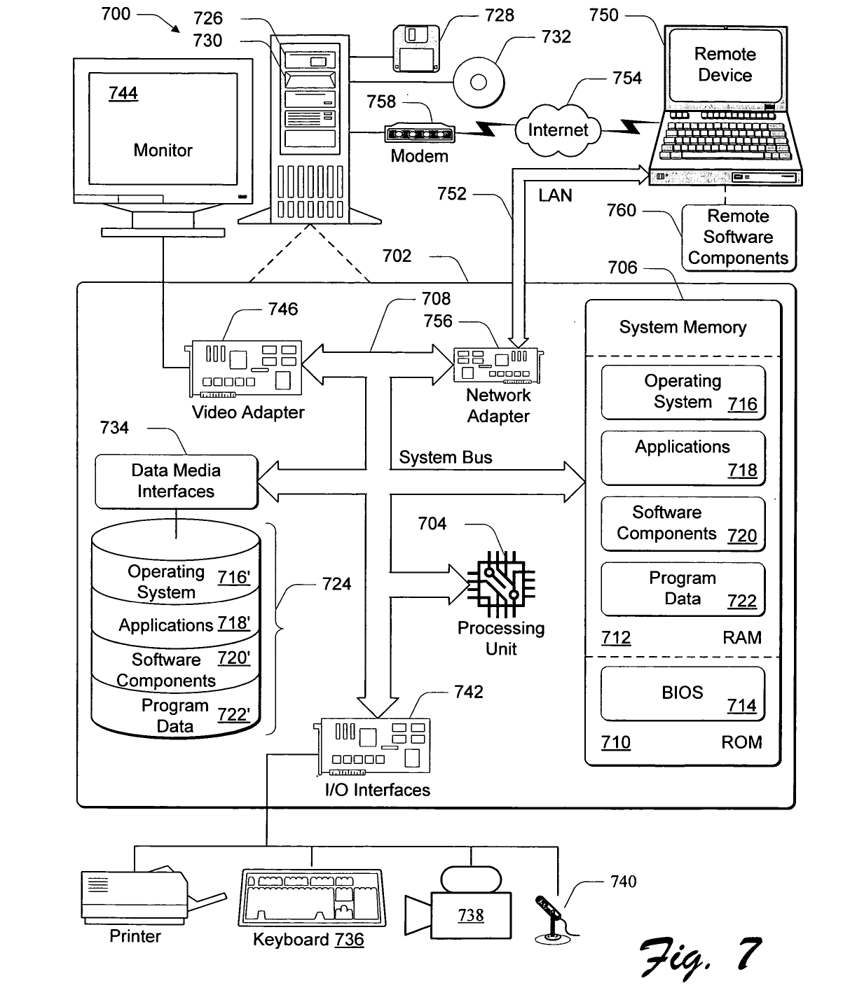

The various components and functionality described herein are implemented with a number of individual computers. FIG. 7 shows components of a typical example of a computer environment 700, including a computer, referred by to reference numeral 702. The computer 702 may be the same as or different from client 104(n) of FIG. 3. The components shown in FIG. 7 are only examples, and are not intended to suggest any limitation as to the scope of the functionality of the invention; the invention is not necessarily dependent on the features shown in FIG. 7.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, network-ready devices, minicomputers, mainframe computers, distributed computing environments that include any of the above systems or devices, and the like.

The functionality of the computers is embodied in many cases by computer-executable instructions, such as software components, that are executed by the computers. Generally, software components include routines, programs, objects, components, data structures, etc. that perform particular tasks or implement particular abstract data types. Tasks might also be performed by remote processing devices that are linked through a communications network. In a distributed computing environment, software components may be located in both local and remote computer storage media.

The instructions and/or software components are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 7, the components of computer 702 may include, but are not limited to, a processing unit 704, a system memory 706, and a system bus 708 that couples various system components including the system memory to the processing unit 704. The system bus 708 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 702 typically includes a variety of computer-readable media. Computer-readable media can be any available media that can be accessed by computer 702 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital video discs (DVD) or other optical disk storage, magnetic cassettes, magnetic tape, magnetic disk storage or other magnetic storage devices, or any other medium which can be used to store the desired information and which can be accessed by computer 702. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 706 includes computer storage media in the form of volatile and/or nonvolatile memory such as read only memory (ROM) 710 and random access memory (RAM) 712. A basic input/output system 714 (BIOS), containing the basic routines that help to transfer information between elements within computer 702, such as during start-up, is typically stored in ROM 710. RAM 712 typically contains data and/or software components that are immediately accessible to and/or presently being operated on by processing unit 704. By way of example, and not limitation, FIG. 7 illustrates operating system 716, applications 718, software components 720, and program data 722.

The computer 702 may also include other removable/non-removable, volatile/nonvolatile computer storage media. By way of example only, FIG. 7 illustrates a hard disk drive 724 that reads from or writes to non-removable, nonvolatile magnetic media, a magnetic disk drive 726 that reads from or writes to a removable, nonvolatile magnetic disk 728, and an optical disk drive 730 that reads from or writes to a removable, nonvolatile optical disk 732 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 724 is typically connected to the system bus 708 through a non-removable memory interface such as data media interface 734, and magnetic disk drive 726 and optical disk drive 730 are typically connected to the system bus 708 by a removable memory interface.

The drives and their associated computer storage media discussed above and illustrated in FIG. 7 provide storage of computer-readable instructions, data structures, software components, and other data for computer 702. In FIG. 7, for example, hard disk drive 724 is illustrated as storing operating system 716′, applications 718′, software components 720′, and program data 722′. Note that these components can either be the same as or different from operating system 716, applications 718, software components 720, and program data 722. Operating system 716′, applications 718′, software components 720′, and program data 722′ are given different numbers here to illustrate that, at a minimum, they are different copies. A user may enter commands and information into the computer 702 through input devices such as a keyboard 736, and pointing device (not shown), commonly referred to as a mouse, trackball, or touch pad. Other input devices may include source devices (such as a microphone 738 or camera 740 which provide streaming data), joystick, game pad, satellite dish, scanner, or the like. These and other input devices are often connected to the processing unit 702 through an input/output (I/O) interface 742 that is coupled to the system bus, but may be connected by other interface and bus structures, such as a parallel port, game port, or a universal serial bus (USB). A monitor 744 or other type of display device is also connected to the system bus 708 via an interface, such as a video adapter 746. In addition to the monitor 744, computers may also include other rendering devices (e.g., speakers) and one or more printers, which may be connected through the I/O interface 742.

The computer may operate in a networked environment using logical connections to one or more remote computers, such as a remote device 750. The remote device 750 may be the same as or different from the plurality of service providers 102(l)-102(m) and edge server 130 of FIG. 1. The remote device 750 may be a personal computer, a network-ready device, a server, a router, a network PC, a peer device or other common network node, and typically includes many or all of the elements described above relative to computer 702. The logical connections depicted in FIG. 7 include a local area network (LAN) 752 and a wide area network (WAN) 754. Although the WAN 754 shown in FIG. 7 is the Internet, the WAN 754 may also include other networks. Such networking environments are commonplace in offices, enterprise-wide computer networks, intranets, and the like.

When used in a LAN networking environment, the computer 702 is connected to the LAN 752 through a network interface or adapter 756. When used in a WAN networking environment, the computer 702 typically includes a modem 758 or other means for establishing communications over the Internet 754. The modem 758, which may be internal or external, may be connected to the system bus 708 via the I/O interface 742, or other appropriate mechanism. In a networked environment, program modules depicted relative to the computer 702, or portions thereof, may be stored in the remote device 750. By way of example, and not limitation, FIG. 7 illustrates remote software components 760 as residing on remote device 750. It will be appreciated that the network connections shown are exemplary and other means of establishing a communications link between the computers may be used.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
exposing one or more web services over a web service interface to a plurality of applications, wherein:
each said web service relates to television programming; and
one said application is not compatible with another said application; and
processing one or more requests received at the web service interface from at least one said application by a said web service corresponding to the at least one said application.

2. The method as described in claim 1, wherein:
the request is received at the web service interface over a wide area network (WAN) by an edge server;
a first said television web service is provided by a first service provider communicatively coupled to the at least one said application over the WAN; and
a second said television web service is provided by a second service provider communicatively coupled to the at least one said application through the edge server.

3. The method as described in claim 1, wherein the request is:
initiated by a client communicatively coupled to a network;
received at the web service interface over the network by an edge server; and
routed to a server communicatively coupled to the network that provides the corresponding said web service.

4. The method as described in claim 1, wherein each said web service is selected from the group consisting of:
video-on-demand (VOD) service;
electronic programming guide (EPG) service;
pay-per-view (PPV) service;
network digital video recorder (NDVR) service;
enhanced television programming service;
television program searching service;
digital rights management (DRM) service; and
television-commerce (t-commerce) service.

5. The method as described in claim 1, further comprising:
publishing a web services description language (WSDL) document that defines application-level behavior for interacting with the one or more web services via the web service interface; and
configuring each said application based on the WSDL document to form the one or more requests.

6. The method as described in claim 1, further comprising communicating a result of the processing to the at least one said application over a wide area network through the web service interface.

7. One or more computer readable media comprising computer executable instructions that, when executed by a computer, direct the computer to perform the method of claim 1.

8. A method comprising:
publishing a web services description language (WSDL) document that defines application-level behavior for interacting with one or more web services via a web service interface, wherein each said web service relates to television programming; and
configuring a client based on the WSDL document to form a request for:
communication to the web service interface;
routing by the web service interface to a corresponding said web service; and
processing by the corresponding said web service.

9. The method as described in claim 8, wherein the configuring includes configuring one or more applications for execution on the client such that each said application provides one or more said requests configured in accordance with the WSDL document.

10. The method as described in claim 8, wherein the at least one said web service communicates a result of the processing to the client through the web service interface.

11. The method as described in claim 8, wherein:
the web service interface is configured to route the request over a wide area network to one or more of a plurality of service providers; and
the one or more service providers provide the at least one said web service.

12. The method as described in claim 8, wherein the web service interface is configured to:
translate the request such that the translated request is configured for the processing; and
route the translated request to the at least one said web service.

13. The method as described in claim 8, wherein each said web service is selected from the group consisting of:
VOD service;
EPG service;
PPV service;
NDVR service;
enhanced television programming service;
television program searching service;
DRM service; and
t-commerce service.

14. One or more computer readable media comprising computer executable instructions that, when executed by a computer, direct the computer to perform the method of claim 8.

15. A method comprising:
receiving a request for a television web service at an Application Program Interface (API) executed on an edge server from one of a plurality of applications executed on a client;
routing the request by the API to a corresponding one of a plurality of service providers that is configured to provide the television web service;
receiving a response at the API from the corresponding service provider that includes a processing of the request by the television web service; and
communicating the response to the one said application.

16. The method as described in claim 15, further comprising translating the received request at the API for processing by the television web service.

17. The method as described in claim 15, further comprising translating the response at the API such that the translated response is compatible with the application.

18. The method as described in claim 15, wherein the television web service is selected from the group consisting of:
VOD service;
EPG service;
PPV service;
NDVR service;
enhanced television programming service;
television program searching service;
DRM service; and
t-commerce service.

19. One or more computer readable media comprising computer executable instructions that, when executed by a computer, direct the computer to perform the method of claim 15.

20. An API comprising a web service interface for exposing web services to one or more independent applications, wherein:
each said web service includes one or more methods callable by each said independent application over the Internet through the web service interface;
each said independent application is executable on a respective client;
the one or more callable methods accept arguments;
the arguments are passable through the web service interface and routed to a corresponding one or more said web services; and
the web services relate to television programming.

21. The API as described in claim 20, wherein one said application is not compatible with another said application.

22. The API as described in claim 20, wherein:
each said web service is provided by one or more of a plurality of service providers; and
the web service interface is configured to pass the arguments to one or more of the plurality of service providers that provide a corresponding said web service.

23. The API as described in claim 20, wherein the web service interface is configured to translate the arguments for processing by a corresponding said web service.

24. The API as described in claim 20, wherein the web service interface is configured to translate responses from the one or more said web services to the independent applications.

25. The API as described in claim 20, wherein a first said application that is executable on a first said client is not compatible with a second said client.

26. The API as described in claim 20, wherein the web services are selected from the group consisting of:
VOD service;
EPG service;
PPV service;
NDVR service;
enhanced television programming service;
television program searching service;
DRM service; and
t-commerce service.

27. A system comprising:
a WAN;
a plurality of service providers communicatively coupled to the WAN, wherein each said service provider is configured to provide one or more television web services;
a plurality of applications, wherein each said application is executable to form one or more requests for communication over the WAN; and
an API including one or more web service interfaces for exposing each said television web service that processes the one or more requests to each said application.

28. The system as described in claim 27, wherein:
a first said application is executable on a first client;
a second said application is executable on a second client; and
the API is executable on an edge server.

29. The system as described in claim 28, wherein the first said application is not compatible with the second client.

30. The system as described in claim 27, wherein the WAN includes the Internet.

31. The system as described in claim 27, wherein the API is configured to route the one or more requests to respective said television web services.

32. The system as described in claim 27, wherein the API is configured to translate the one or more requests for processing by a corresponding said television web service.

33. The system as described in claim 27, wherein the API is configured to translate responses to the requests from the plurality of service providers to corresponding said applications.

34. The system as described in claim 27, wherein the API is configured to route responses to the requests from the plurality of service providers to corresponding said applications.

35. The system as described in claim 27, wherein a first said application that is executable on a first client is not compatible with a second client that executes a second said application.

36. The system as described in claim 27, wherein the television web services are selected from the group consisting of:
VOD service;
EPG service;
PPV service;
NDVR service;
enhanced television programming service;
television program searching service;
DRM service; and
t-commerce service.

37. A system comprising:
a network;
means for requesting one or more of a plurality of television web services, wherein the requesting means are communicatively coupled to the network;
means for executing the plurality of television web services, wherein the executing means are communicatively coupled to the network; and
means for interfacing the requesting means with the executing means such that the television web services are exposed for processing one or more requests originating from the requesting means.

38. The system as described in claim 37, wherein the television web services are selected from the group consisting of:
VOD service;
EPG service;
PPV service;
NDVR service;
enhanced television programming service;
television program searching service;
DRM service; and
t-commerce service.
